(19) United States
(12) Patent Application Publication
(10) Pub. No.: US 2013/0139042 A1
(43) Pub. Date: May 30, 2013

(54) GENERATING AND PROVIDING GUIDANCE FILES FOR DOCUMENTS

(71) Applicants: Anil Kumar Padala, Flower Mound, TX (US); Manah Khalil, Irving, TX (US); Senthil Muthusamy, Lewisville, TX (US); Swaroop Mallampalli, Irving, TX (US)

(72) Inventors: Anil Kumar Padala, Flower Mound, TX (US); Manah Khalil, Irving, TX (US); Senthil Muthusamy, Lewisville, TX (US); Swaroop Mallampalli, Irving, TX (US)

(73) Assignee: VERIZON PATENT AND LICENSING INC., Basking Ridge, NJ (US)

(21) Appl. No.: 13/307,730

(22) Filed: Nov. 30, 2011

(51) Int. Cl. G06F 15/16

(52) U.S. Cl. 715/205

(57) ABSTRACT

A method, performed by a computer device, may include generating a guidance file for a document, where the guidance file includes guidance instructions for one or more interactive elements in the document; a script file configured to cause the guidance file to be accessed and to provide the guidance instructions in connection with the one or more interactive elements; and adding an instruction to the document to run the script file when the document is accessed.

### BACKGROUND INFORMATION

A document may include an interactive element, such as a text box, which may be used to receive input from a user. The interactive element may be incorporated into the document by adding code to the document, wherein the added code causes an application to display the interactive element and configures the interactive element to receive input from the user. When filling out a form on a web document, a user may need to interact with a large number of interactive elements to successfully complete the form. For example, a sales representative may fill out a form document when taking an order from a customer. The sales representative may be trained in how to fill out the form document by providing guidance instructions and by validating that the sales representative followed the guidance instructions to fill out the form document correctly. For example, another version of the form document with the guidance instructions may need to be maintained. However, maintaining another version of the form document may be inefficient.

### BRIEF DESCRIPTION OF THE DRAWINGS

FIG. 1 is a diagram illustrating an exemplary environment according to an implementation described herein;

FIG. 2 is a diagram illustrating exemplary components of the document guidance system of FIG. 1;

FIG. 3 is a diagram illustrating exemplary functional components of the document guidance system of FIG. 1;

FIG. 4A is a diagram illustrating exemplary components of a script file according to an implementation described herein;

FIG. 4B is a diagram illustrating exemplary components of a guidance file according to an implementation described herein;

FIG. 5 is a flow chart of an exemplary process for generating and providing guidance and script files for a document according to an implementation described herein;

FIG. 6 is a flow chart of a first exemplary process for generating a guidance file according to an implementation described herein;

FIGS. 7A-7B are flow charts of a second exemplary process for generating a guidance file according to an implementation described herein;

FIG. 8 is a flow chart of a first exemplary process for processing a guidance file according to an implementation described herein;

FIG. 9 is a flow chart of a second exemplary process for processing a guidance file according to an implementation described herein;

FIGS. 10A-10B are diagrams of a first example of processing a guidance file according to an implementation described herein;

FIGS. 11A-11B are diagrams of a second example of processing a guidance file according to an implementation described herein;

FIGS. 12A-12B are diagrams of a third example of processing a guidance file according to an implementation described herein;

FIGS. 13A-13B are diagrams of a fourth example of processing a guidance file according to an implementation described herein; and

FIGS. 14A-14B are diagrams of a fifth example of processing a guidance file according to an implementation described herein.

### DETAILED DESCRIPTION OF PREFERRED EMBODIMENTS

The following detailed description refers to the accompanying drawings. The same reference numbers in different drawings identify the same or similar elements.

An implementation described herein may relate to generating and providing a guidance file for a document. A document may include one or more interactive elements. An interactive element may correspond to a component of the document via which a user may provide input to the document. Examples of interactive components may include a text box through which a user may enter text, a button, a check box, a radio button, a drop down menu or another type of menu, a slider, a text area that includes editable text, a scroll bar, a clickable image, and/or any other type of interactive element in a document that may receive user input.

The guidance file may guide a user through a sequence of interaction elements in a document. For example, a sales representative may be trained how to fill out a form document by following a sequence of guidance instructions for entry fields included in the document. A company may maintain a large number of documents that may need to train a sales representative through multiple scenarios for each document. For example, each document may be associated with a different product, service, or customer problem and the sales representative may need to learn how to handle different situations to fill out documents correctly. A guidance file may be maintained independently of a document and may be changed to reflect different training scenarios without having to change the document. Additionally or alternatively, multiple guidance files may be maintained for a document. A guidance file may also be provided to a user to help guide a user through a document (e.g., if the document may appear to be complicated to the user). For example, the guidance file may include additional instructions that may be subject to change and may be changed without having to change the document.

A guidance file may be generated for a document by identifying interaction elements included in the document, determining a sequence for the identified interaction elements, and generating guidance instructions for the identified interaction elements. Furthermore, if the guidance file is for training purposes, the guidance file may include validation instructions that may be used to validate user input received via an interaction element. The validation instructions may be used to ensure that a user is able to process a document correctly.

A script file may be generated to process a guidance file for a document. An instruction may be added to the document to am the script file. When a user accesses the document with a browser application, the instruction added to the document may cause the browser application to retrieve and run the script file. The script file may retrieve guidance instructions for interaction elements in the document from the guidance file and may provide the guidance instructions in connection with the interaction elements. For example, a script tag may be added to the document to invoke the script file. For example, the script file may identify an interaction element in the document, may highlight the interaction element, and may provide the guidance instructions within a particular distance of the interaction element displayed in the document.

In one implementation, the guidance file may correspond to an Extensible Markup Language (XML) file. In another implementation, the guidance file may correspond to a different type of file. In one implementation, the script file may correspond to a Javascript file. In another implementation, the script file may correspond to a different type of script file.

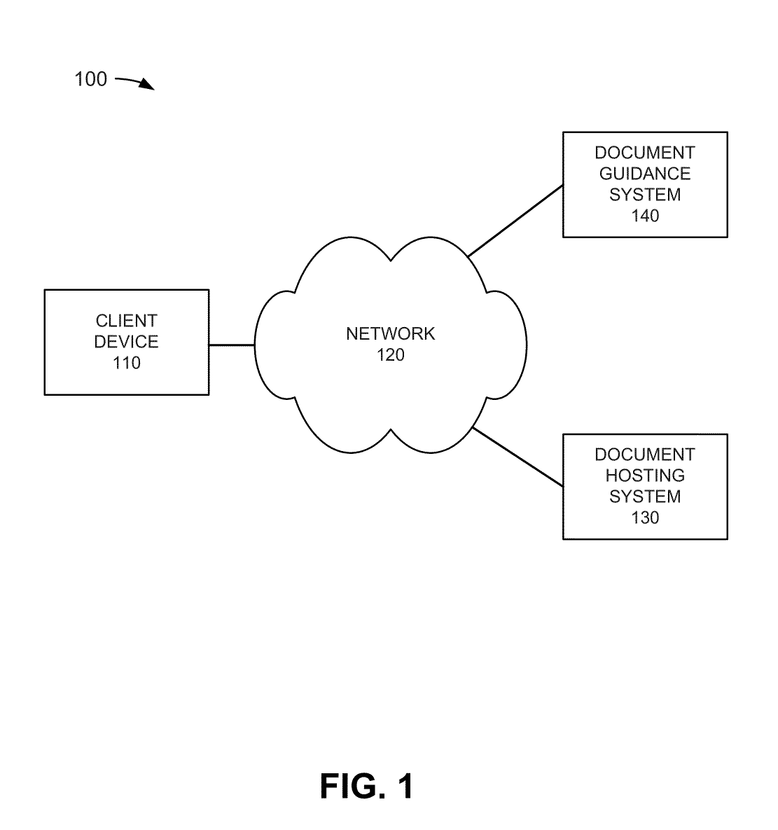

FIG. 1 is a diagram of an exemplary environment 100 in which the systems and/or methods described herein may be implemented. As shown in FIG. 1, environment 100 may include a client device 110, a network 120, a document hosting system 130, and a document guidance system 140. While FIG. 1 depicts a single client device 110, a single document hosting system 130, and a single document guidance system 140 for illustrative purposes, in practice, environment 100 may include multiple client devices 110, multiple document hosting systems 130, and/or multiple document guidance systems 140.

Client device 110 may include any device capable of accessing document across a network using, for example, a browser application (e.g., Internet Explorer, Mozilla Firefox, Google Chrome, Apple Safari, Opera, etc.). Client device 110 may access a document hosted by document hosting system 130. Client device 110 may include a desktop computer; a laptop computer; a tablet computer; a mobile communication device, such as a mobile phone, a smart phone, a tablet computer, a laptop, a personal digital assistant (PDA), or another type of portable communication device; and/or another type of computation and/or communication device.

Network 120 may enable client device 110, document hosting system 130, and document guidance system 140 to communicate with each other. Network 120 may include one or more wired and/or wireless networks. For example, network 120 may include a cellular network, the Public Land Mobile Network (PLMN), a second generation (2G) network, a third generation (3G) network, a fourth generation (4G) network (e.g., a long term evolution (LTE) network), a fifth generation (5G) network, a code division multiple access (CDMA) network, a global system for mobile communications (GSM) network, a general packet radio services (GPRS) network, a combination of the above networks, and/or another type of wireless network. Additionally, or alternatively, network 120 may include a local area network (LAN), a wide area network (WAN), a metropolitan area network (MAN), an ad hoc network, an intranet, the Internet, a fiber optic-based network (e.g., a fiber optic service network), a satellite network, a television network, and/or a combination of these or other types of networks.

Document hosting system 130 may include one or more computing devices, such as server devices, that host documents. For example, document hosting system 130 may include a server device that stores a document that includes one or more interactive elements. The document may be accessed by a user of client device 110 using a browser application, provided to client device 110, and displayed by client device 110 to the user. The user may provide input in connection with an interactive element in the document (e.g., by entering text into a text box) and client device 110 may send information associated with the input to document hosting system 130. Document hosting system 130 may store the received information and associate the received information with the interactive element and with client device 110.

Document guidance system 140 may include one or more computing devices, such as server devices, that generate and/or provide a guidance file for a particular document hosted by document hosting system 130. For example, the particular document may include an instruction to activate a script stored in document guidance system 140. When the browser application of client device 110 accesses the particular document, the browser application may execute the instruction and activate the script. The script may retrieve a guidance file, associated with the particular document and stored by document guidance system 140, and may use the guidance file to provide guidance instructions to client device 110 in connection with the particular document. Furthermore, in one implementation, the script may validate user input based on information included in the guidance file. Moreover, document guidance system 140 may generate a guidance file and/or script file for a document.

Although FIG. 1 shows exemplary components of environment 100, in other implementations, environment 100 may include fewer components, different components, differently arranged components, or additional components than depicted in FIG. 1. Additionally or alternatively, one or more components of environment 100 may perform functions described as being performed by one or more other components of environment 100.

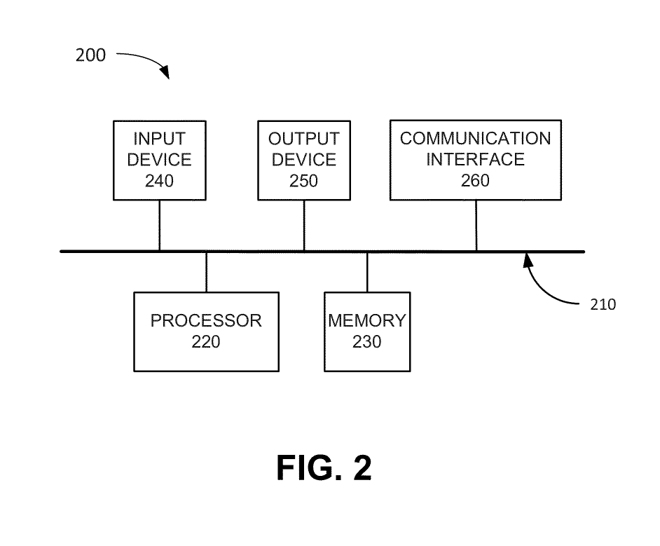

FIG. 2 is a diagram illustrating example components of a device 200 according to an implementation described herein. Client device 110, document hosting system 130, and/or document guidance system 140 may each include one or more devices 200. As shown in FIG. 2, device 200 may include a bus 210, a processor 220, a memory 230, an input device 240, an output device 250, and a communication interface 260.

Bus 210 may include a path that permits communication among the components of device 200. Processor 220 may include any type of single-core processor, multi-core processor, microprocessor, latch-based processor, and/or processing logic (or families of processors, microprocessors, and/or processing logics) that interprets and executes instructions. In other embodiments, processor 220 may include an application-specific integrated circuit (ASIC), a field-programmable gate array (FPGA), and/or another type of integrated circuit or processing logic.

Memory 230 may include any type of dynamic storage device that may store information and/or instructions, for execution by processor 220, and/or any type of non-volatile storage device that may store information for use by processor 220. For example, memory 230 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 240 may allow an operator to input information into device 200. Input device 240 may include, for example, a keyboard, a mouse, a pen, a microphone, a remote control, an audio capture device, an image and/or video capture device, a touch-screen display, and/or another type of input device. In some embodiments, device 200 may be managed remotely and may not include input device 240. In other words, device 200 may be “headless” and may not include a keyboard, for example.

Output device 250 may output information to an operator of device 200. Output device 250 may include a display, a printer, a speaker, and/or another type of output device. For example, device 200 may include a display, which may include a liquid-crystal display (LCD) for displaying content to the customer. In some embodiments, device 200 may be managed remotely and may not include output device 250. In other words, device 200 may be “headless” and may not include a display, for example.

Communication interface 260 may include a transceiver that enables device 200 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 260 may include a transmitter that converts baseband signals to radio frequency (RF) signals and/or a receiver that converts RF signals to baseband signals. Communication interface 260 may be coupled to an antenna for transmitting and receiving RF signals.

Communication interface 260 may include a logical component that includes input and/or output ports, input and/or output systems, and/or other input and output components that facilitate the transmission of data to other devices. For example, communication interface 260 may include a network interface card (e.g., Ethernet card) for wired communications and/or a wireless network interface (e.g., a WiFi) card for wireless communications. Communication interface 260 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 200 may perform certain operations relating to management of information associated with users and to providing updated information about a user's contacts to the user. Device 200 may perform these operations in response to processor 220 executing software instructions contained in a computer-readable medium, such as memory 230. A computer-readable medium may be defined as a non-transitory memory device. A memory device may be implemented within a single physical memory device or spread across multiple physical memory devices. The software instructions may be read into memory 230 from another computer-readable medium or from another device. The software instructions contained in memory 230 may cause processor 220 to perform processes described herein. Alternatively, hardwired circuitry may be used in place of, or in combination with, software instructions to implement processes described herein. Thus, implementations described herein are not limited to any specific combination of hardware circuitry and software.

Although FIG. 2 shows exemplary components of device 200, in other implementations, device 200 may include fewer components, different components, additional components, or differently arranged components than depicted in FIG. 2. Additionally or alternatively, one or more components of device 200 may perform one or more tasks described as being performed by one or more other components of device 200.

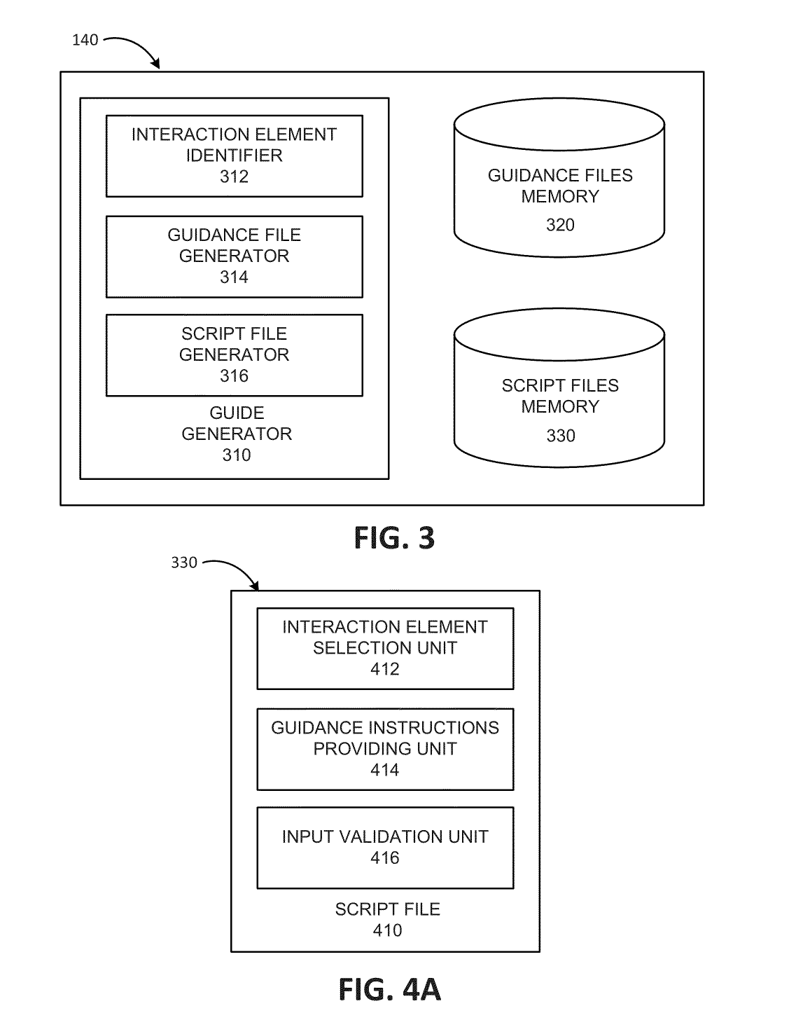

FIG. 3 is a diagram of exemplary functional components of document guidance system 140. The functional components of document guidance system 140 may be implemented, for example, via processor 220 executing instructions from memory 230. As shown in FIG. 3, document guidance system 140 may include a guide generator 310, a guidance files memory 320, and a script files memory 330.

Guide generator 310 may generate a guidance file and/or a script file for a particular document. Guide generator 310 may include an interaction element identifier 312, a guidance file generator 314, and a script file generator 316.

Interaction element identifier 312 may analyze a document and identify interaction elements included in the document. For example, interaction element identifier 312 may process the document to identify tags indicative of interactive elements (e.g., HTML tags that include terms such as “form,” “input,” “select,” etc.) and/or tags indicative of editable text (e.g., HTML tags that include the term “text area,” etc.). Furthermore, interaction element identifier 312 may determine a sequence for the identified interaction elements. A sequence for the identified interaction elements may be identified based on, for example, a sequence of the identified interaction elements in the document code and/or a sequence specified by an administrator that requested generation of a guidance file for the document.

Guidance file generator 314 may generate a guidance file for the document. In one implementation, guidance file generator 314 may generate an XML file. In another implementation, guidance file generator 314 may generate the guidance file in another format. For example, guidance file generator 314 may generate guidance instructions and/or validation instructions for one or more of the interaction elements identified by the interaction element identifier 312. For each interaction element, guidance file generator 314 may generate guidance instructions by, for example, prompting an administrator that requested generation of the guidance file to input instructions that are to be provided to the user in connection with the interaction element. Similarly, guidance file generator 314 may prompt the administrator to input validation instructions that are to be used to validate user input for the interaction element. Moreover, guidance file generator 314 may identify a next interaction element that is to be processed by, for example, prompting the administrator to identify a next interaction element in a sequence of interaction elements.

Script file generator 316 may generate a script file for the document. In one implementation script file generator 316 may generate a javascript file. In another implementation, script file generator 316 may generate the script file in another scripting language. For example, upon execution, a script file may access the generated guidance file and may provide guidance instructions for the interaction elements in the document based on a sequence of interaction elements specified in the guidance file.

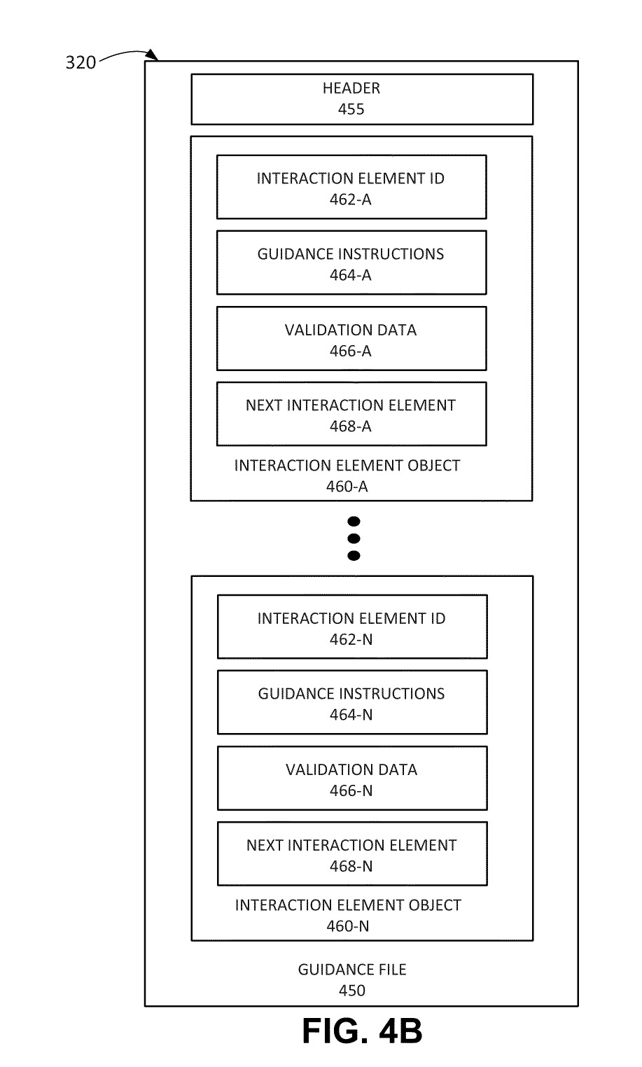

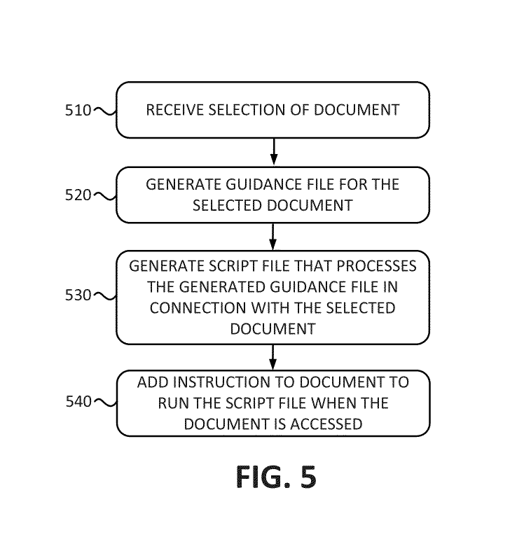

Guidance files memory 320 may store guidance files generated by guide generator 310 for particular documents. An exemplary guidance file that may be stored in guidance files memory 320 is described below with reference to FIG. 4B. Script files memory 330 may store script files generated by guide generator 310 to process guidance files stored in guidance files memory 320. An exemplary script file that may be stored in script files memory 330 is described below with reference to FIG. 4A.

Although FIG. 3 shows exemplary functional components of document guidance system 140, in other implementations, document guidance system 140 may include fewer functional components, different functional components, differently arranged functional components, or additional functional components than depicted in FIG. 3. Additionally or alternatively, one or more functional components of document guidance system 140 may perform functions described as being performed by one or more other functional components of document guidance system 140.

FIG. 4A is a diagram of an exemplary script file 410 that may be stored in script files memory 330. Script file 410 may include an instruction to access a particular guidance file stored in guidance files memory 320. In one implementation, script file 410 may process guidance files associated with different documents. In other words, script file 410 may be able to process multiple guidance files. In another implementation, a particular script file 410 may be associated with a particular guidance file. As shown in FIG. 4A, script file 410 may include an interaction element selection unit 412, a guidance instructions providing unit 414, and an input validation unit 416.

Interaction element selection unit 412 may select a next interaction element to be processed. For example, after processing an interaction element, interaction element selection unit 412 may identify a next interaction element identified in the guidance file. Guidance instructions providing unit 414 may retrieve guidance instructions, associated with the interaction element selected by interaction element selection unit 412, and may provide the retrieved guidance instructions to the user in connection with the interaction element. For example, guidance instructions providing unit 414 may identify a location, on a screen displaying the document, of the identified interaction element and may display the guidance instructions within a particular distance of the identified interaction element as displayed. The guidance instructions may be displayed based on a format and/or style specified in the guidance file. For example, the guidance file may specify a particular font, a particular color, and/or a particular graphical box that is to be used to display the guidance instructions. Furthermore, guidance instructions providing unit 414 may highlight the identified interaction element in the document in connection with displaying the guidance instruction. Additionally or alternatively, the guidance instructions may be provided in an audio format. For example, the guidance instructions may be used to help a blind person fill out a document form.

Input validation unit 416 may determine whether validation instructions are included in the guidance file for the identified interaction element and, if validation instructions are included, may validate user input with respect to the validation instructions. For example, input validation unit 416 may determine whether user input text matches text included in the validation instructions. As another example, input validation unit 416 may determine whether a user selection of a particular option from a list of options matches an option indicated in the validation instructions.

Although FIG. 4A shows exemplary fields that may be included in script file 410, in other implementations, script file 410 may include fewer fields, different fields, differently arranged fields, and/or additional fields than depicted in FIG. 4A.

FIG. 4B is a diagram of exemplary information that may be stored in guidance files memory 320. As shown in FIG. 4, guidance files memory 320 may include one or more guidance files 450 (referred to herein collectively as “guidance files 450” and individually as “guidance file 450”). Guidance file 450 may include a header 455 and one or more interaction element objects 460-A to 460-N (referred to herein collectively as “interaction element objects 460” and individually as “interaction element object 460”).

Header 455 may store information about the guidance file. For example, if the guidance file corresponds to an XML file, the header may be an XML header. The XML header may identify a document type definition (DTD) file that defines elements and/or references used by the guidance file. Furthermore, header 455 may include guidance instructions not associated with a particular interaction element. For example, header 455 may include guidance instructions that inform a user that the user is about to be guided through the interaction elements in the document, a message that is to be provided to the user if validation of user input fails for a particular interaction element, guidance instructions that inform the user that a document form has been successfully completed, and/or any other information not directly related to a particular interaction element.

Each interaction element object 460 may be associated with a particular interaction element in the particular document. Not all interaction elements in the document need be referenced in guidance file 450. Interaction element 460 may include an interaction element identification (ID) field 462, a guidance instructions field 464, a validation data field 466, and a next interaction element field 468.

Interaction element ID field 462 may include information identifying the particular interaction element. For example, interaction element ID field 462 may include an identifier, associated with the particular interaction element, which corresponds to an identifier included in the document.

Guidance instructions field 464 may include information associated with guidance instructions for the interaction element. For example, guidance instructions field 464 may include text that is to be provided to a user in connection with the particular interaction element. Furthermore, guidance instructions field 464 may include information identifying a particular graphical format in which the guidance instructions are to be provided.

Validation data field 466 may include information that may be used to validate user input associated with the particular interaction element. In one implementation, if guidance file 450 is a training file and if the guidance instructions include the text “Please enter ‘John’ in the first name field,” validation data field 466 may include the text “John.” A script file may compare the validation data with input received from the user to validate that the user has entered the correct input. In another implementation, if guidance file 450 corresponds to a file to help a user fill out a document form, without having to verify a particular input, validation data field 466 may include information about a particular format of input. For example, if the user is required to enter 4 digits of a social security number, validation data field 466 may include information specifying that the input should be 4 digits. In yet another implementation, validation data field 466 need not include any information and validation of user input in connection with the particular interaction element need not be performed.

Next interaction element field 468 may include information identifying a next interaction element in a sequence of interaction elements. For example, next interaction element field 468 may include an identifier of another interaction element included in the document. Furthermore, if the particular interaction element includes dependencies, next interaction element field 468 may identify an interaction element which may be activated based on user input. For example, assume an interaction element corresponds to a drop down menu that includes an option that, when selected by a user, selects a credit card as a payment method. In such a case, next interaction element field 468 may identify that, if the user input corresponds to a selection of the credit card payment method, the next interaction element corresponds to a text box that enables the user to enter a credit card number.

Although FIG. 4B shows exemplary fields that may be included in guidance file 450, in other implementations, guidance file 450 may include fewer fields, different fields, differently arranged fields, and/or additional fields than depicted in FIG. 4B.

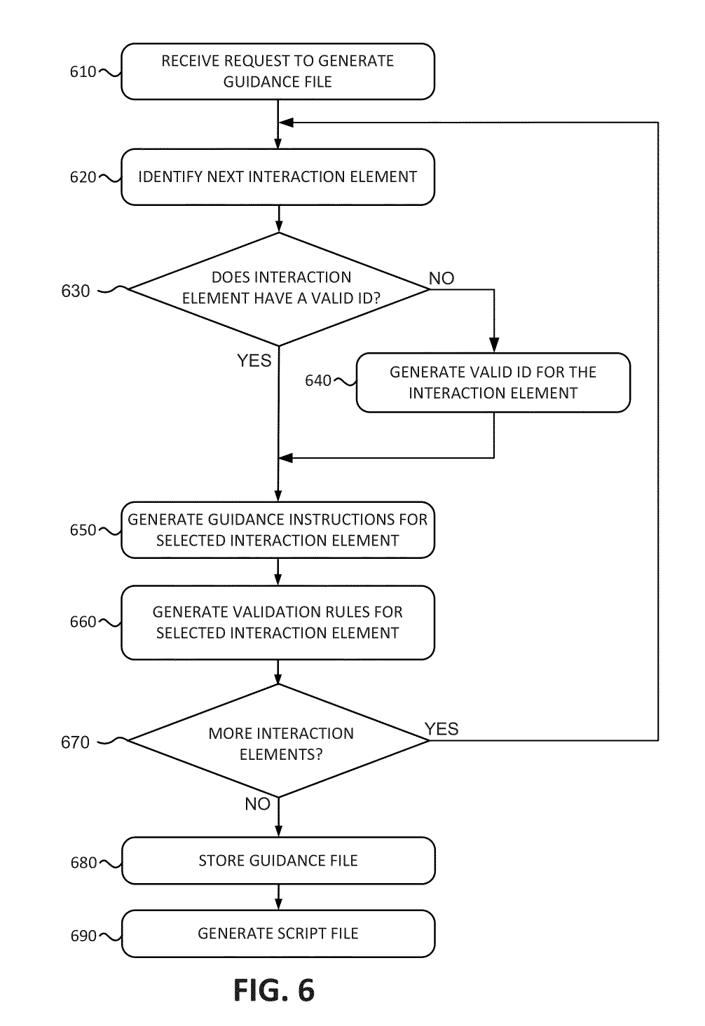

FIG. 5 is a flow chart of an exemplary process for generating and providing a guidance file for a document according to an implementation described herein. In one implementation, the process of FIG. 5 may be performed by document guidance system 140. In other implementations, some or all of the process of FIG. 5 may be performed by another device or a group of devices separate from document guidance system 140 and/or including document guidance system 140.

The process of FIG. 5 may include receiving a selection of a document (block 510), For example, an administrator of a particular document may select the document and may send a request to document guidance system 140 to generate a guidance file and/or a script file for the selected document. In one example, the administrator may request to generate a training file to train a sales representative in how to fill out the selected document. In another example, the administrator may request to generate a file that guides a user through a process of filling out a form in a particular order. In one implementation, the administrator may initiate the request and select of the document via client device 110. In another implementation, the administrator may initiate the request and select the document via input device 240 associated with document hosting system 130. In yet another implementation, the administrator may initiate the request and select the document via input device 240 associated with document guidance system 140.

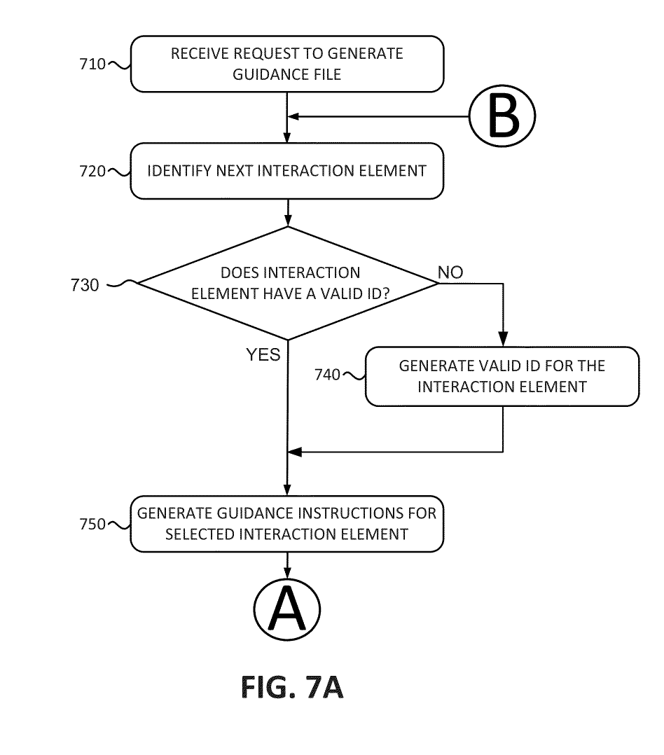

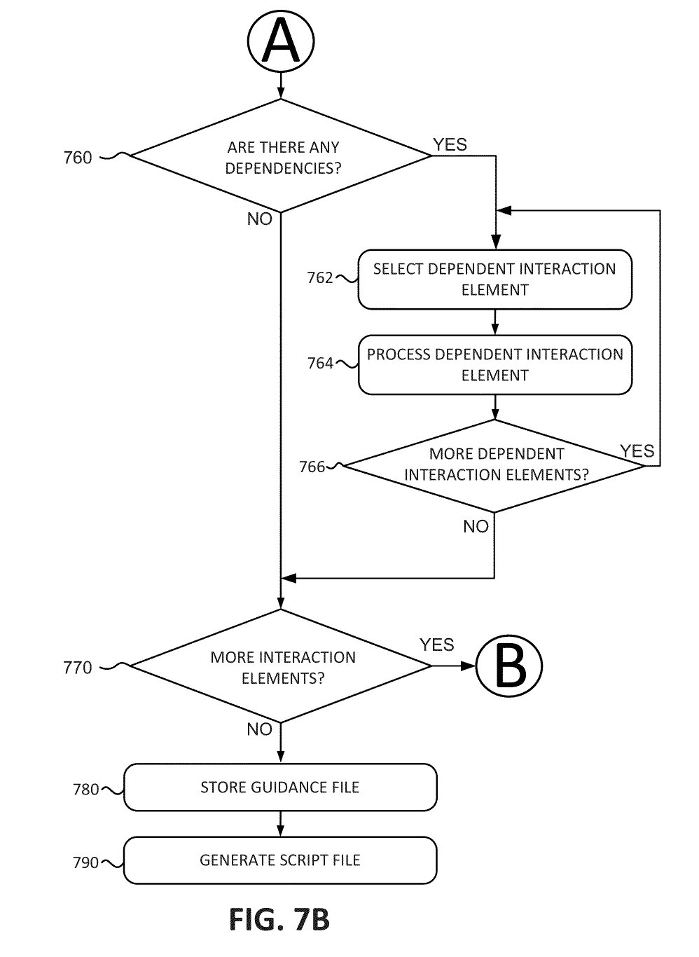

A guidance file for the selected document may be generated (block 520). For example, guide generator 310 may display the selected document in output device 250 associated with the administrator. Guide generator 310 may identify interaction elements associated with the document and may request that the administrator select a sequence for the interaction elements (e.g., via input device 240). Guide generator 310 may further request that the administrator enter guidance instructions and validation instructions for each selected interaction element. Generation of a guidance file is described below in more detail with reference to FIGS. 6 and 7A-7B.

A script file may be generated that processes the generated guidance file in connection with the selected document (block 530). For example, guide generator 310 may generate a script file that accesses the guidance file for the selected document and that provides guidance instructions and/or validation instructions for the selected interaction elements in the document in the sequence specified by the administrator.

An instruction may be added to the selected document to run the script file when the selected document is accessed (block 540). For example, guide generator 310 may insert an instruction into code (e.g., HTML code) associated with the document, wherein the instruction activates the script file when the document is accessed.

As an example, the script file may be invoked by adding a <SCRIPT SRC=“guidance.js”/>tag to the document to invoke an external script file with the name “guidance.js.” The script file may identify a guidance file for the document based on a naming convention and by parsing the name of the document. For example, if the document has the name “mywebpage.aspx,” the script file may retrieve a guidance file with the name “mywebpage.guidance.xml.” Thus, a same script file may be used with multiple documents.

If the administrator decides to change the training file or the guidance instructions at a later time, the administrator may only need to change the guidance file and/or the script file, without having to change the code associated with the document.

FIG. 6 is a flow chart of a first exemplary process for generating a guidance file according to an implementation described herein. The process of FIG. 6 may relate to generating a guidance file for training a user to interact with a document. Thus, the process of FIG. 6 may include processing of validation rules to determine whether a user has interacted with the document based on the requirements of the training. In one implementation, the process of FIG. 6 may be performed by document guidance system 140. In other implementations, some or all of the process of FIG. 6 may be performed by another device or a group of devices separate from document guidance system 140 and/or including document guidance system 140.

The process of FIG. 6 may include receiving a request to generate a guidance file (block 610). For example, guide generator 310 may receive a request to generate a guidance file for a particular document. Interaction element identifier 312 may process the document to identify interaction elements. In one implementation, interaction element identifier 312 may identify particular Hypertext Markup Language (HTML) tags associated with interaction elements. For example, interaction element identifier 312 may identify tags that include the term “form” (e.g., <form action=“ ”>); tags that include the term “input” (e.g., <input type=“text”/>, <input type=“password”/>, <input type=“radio”/>, <input type=“checkbox”/>, <input type=“submit”/>, etc.); tags that include the term “select” and/or the term “option” (e.g., <select> <option value=“option1”option_{—}1</option> </select>); tags that include a term indicative of editable text, such as “text area” (e.g., <textarea row=“20” cols=“15”> This text is editable by a user </textarea>); and/or any other tags that include a term indicative of an interaction element in the document. In another implementation, interaction element identifier 312 may prompt an administrator to identify interaction elements in the document using an input device. In yet another implementation, interaction element identifier 312 may identify interaction elements in the document using another technique, such as, for example, comparing the document to another document that includes previously identified interaction elements.

Furthermore, guide generator 310 may determine a sequence for the identified interaction elements. In one implementation, the sequence for the identified interaction elements may be determined based on a sequence of the interaction elements in the document. For example, a first interaction element closer to the top or beginning of the document may be determined to occur before a second interaction element closer to the end or bottom of the document. In another implementation, interaction element identifier 312 may prompt an administrator to identify a sequence for the determined interaction elements.

A next interaction element may be identified (block 620). For example, guide generator 310 may select a next interaction element from the determined sequence of interaction elements. Guide generator 310 may select a first interaction element in the sequence during a first iteration of the process, may select a second interaction element in the sequence during a second iteration of the process, etc.

A determination may be made as to whether the identified interaction element has a valid identifier (block 630). For example, interaction element identifier 312 may analyze the tag associated with the identified interaction element to determine whether the interaction element includes an identifier. If it is determined that the interaction element does not have a valid identifier (block 630—NO), a valid identifier may be generated for the interaction element (block 640). For example, interaction element identifier 312 may modify the tag associated with the interaction element to add an identifier to the tag. Processing may continue to block 650.

If it is determined that the interaction element does have a valid identifier (block 630—YES), guidance instructions may be generated for the identified interaction element (block 650). For example, guidance instructions generator 314 may generate guidance instructions for the identified interaction element. In one implementation, guidance instructions generator 314 may prompt the administrator to enter the guidance instructions for the identified interaction element. For example, the administrator may enter text that is to be displayed to the user in connection with the interaction element. In another implementation, guidance instructions generator 314 may generate the guidance instructions using another technique, such as, for example, using a table that relates particular interaction elements to particular guidance instructions. Guidance file generator 314 may further include information about style and/or format associated with the guidance instructions (e.g., font, color, text style, display box, whether the instructions are to be provided in an audible format, etc.).

Validation rules may be generated for the selected interaction element (block 660). For example, guidance file generator 314 may generate validation rules for the identified interaction element. In one implementation, guidance tile generator 314 may prompt the administrator to enter the validation rules for the identified interaction element. For example, the administrator may enter text that is to be used to validate input entered by the user via the interaction element. In another implementation, guidance file generator 314 may generate the validation instructions using another technique, such as, for example, by obtaining the validation instructions from the guidance instructions by parsing the validation instructions and recognizing terms indicative of instructions to enter text or select a particular option. For example, if the guidance instructions include the text “Enter ‘John’ as the first name,” then the word “enter” and/or the use of the quotation marks may be used to retrieve the text “John” as the text that is to be used to validate user input. As another example, if the guidance instructions include the text “Select Option 2,” then the use of the word “select” may be used to retrieve the phrase “Option 2” as text that is to be used to validate user input.

A determination may be made as to whether there are more interaction elements (block 670). For example, guide generator 310 may analyze the sequence of interaction elements to determine whether any interaction elements remain to be processed. If it is determined that there are more interaction elements (block 670—YES), processing may return to block 620. For example, interaction element identifier 312 may identify a next interaction element from the sequence. If it is determined that there are no more interaction elements (block 670—NO), processing of interaction elements may be complete and a guidance file may be stored (block 680). For example, guide generator 310 may store the generated guidance file, which may include the generated guidance instructions and validation rules, in guidance files memory 320.

A script file may be generated (block 690). For example, guide generator 310 may generate a script file to process the generated guidance file. The script file may include instructions to retrieve information identifying an interaction element from the guidance file, identify the interaction element in the document, provide guidance instructions from the guidance file in connection with the interaction element in the document, validate user input received via the interaction element, and identify a next interaction element to be processed. The script file may be stored in script files memory 330.

FIGS. 7A-7B are flow charts of a second exemplary process for generating a guidance file according to an implementation described herein. The process of FIGS. 7A-7B may relate to generating a guidance file that guides a user through a document. Thus, the process of FIGS. 7A-7B may include checking for activated dependencies. For example, the code of a document may provide additional interaction elements to the user based on user input. For example, if the user selects a first option for a particular interaction point, the code of the document may provide a first interaction point and if the user selects a second option for the particular interaction point, the document may provide a second interaction point.

In one implementation, the process of FIGS. 7A-7B may be performed by document guidance system 140. In other implementations, some or all of the process of FIGS. 7A-7B may be performed by another device or a group of devices separate from document guidance system 140 and/or including document guidance system 140.

FIG. 7A may include blocks 710-750, which may correspond to blocks 610-650, described above with reference to FIG. 6. Continuing to FIG. 7B, a determination may be made as to whether there are any dependencies for the interaction element identified in block 720. (block 760). For example, guidance file generator 314 may determine whether any interaction elements depend on user input received via the identified interaction element. Guidance file generator 314 may determine that one or more interaction elements depend from the identified interaction element and may determine a sequence for the dependent one or more interaction elements.

In one implementation, dependencies may be identified by analyzing code associated with the identified interaction element. For example, code (e.g., in a scripting language such as javascript) associated with the identified interaction element may include an identifier of another interaction element in connection with particular input. In another implementation, dependencies may be identified based on information received from an administrator that requested generation of the guidance file. For example, the administrator may indicate that a second interaction element depends from a first interaction element and that the second interaction element is activated when particular input is received via the first interaction element.

If it is determined that there are dependencies (block 760—YES), a dependent interaction element may be selected (block 762). For example, guide generator 310 may select a first interaction element from a sequence of dependent interaction elements. The dependent interaction element may be processed (block 764). For example, guide generator 310 may generate guidance instructions for the selected interaction element (as described above with reference to block 650).

Furthermore, guide generator 310 may identify particular user input that activates the dependent interaction element and may include information in next interaction element field 468 of the selected interaction element, identifying the dependent interaction element and particular user input that activates the dependent interaction element. For example, if the selected interaction element includes a set of checkboxes and if one of the checkboxes, when selected, activates a text entry box, the document may include the following code: <input type=“checkbox” onclick=“enter_message( )”/>, wherein the enter_message function may display a text box. Guide generator 310 may identity the term “checkbox” and may also identify that the enter_message function includes a text box interactive element. In response, guide generator 310 may include a tag in next interaction element field 468 of the text box along with the “onclick” condition.

A determination may be made as to whether there are more dependent interaction elements (block 766). For example, guide generator 310 may analyze the sequence of interaction elements, which depend from the selected interaction element, to determine whether any interaction elements remain to be processed. If it is determined that there are more dependent interaction elements (block 766—YES), processing may return to block 762. For example, guide generator 310 may select a next interaction element from the sequence of dependent interaction elements. If it is determined that there are no more dependent interaction elements (block 766—NO), processing may continue to block 770.

A determination may be made as to whether there are more interaction elements (block 770). For example, guide generator 310 may analyze the sequence of interaction elements to determine whether any interaction elements remain to be processed. If it is determined that there are more interaction elements (block 770—YES), processing may return to block 720. For example, interaction element identifier 312 may identify a next interaction element from the sequence. If it is determined that there are no more interaction elements (block 770—NO), processing of interaction elements may be complete and a guidance file may be stored (block 780) and a script file may be generated (block 790), as described above with reference to block 680 and 690 of FIG. 6.

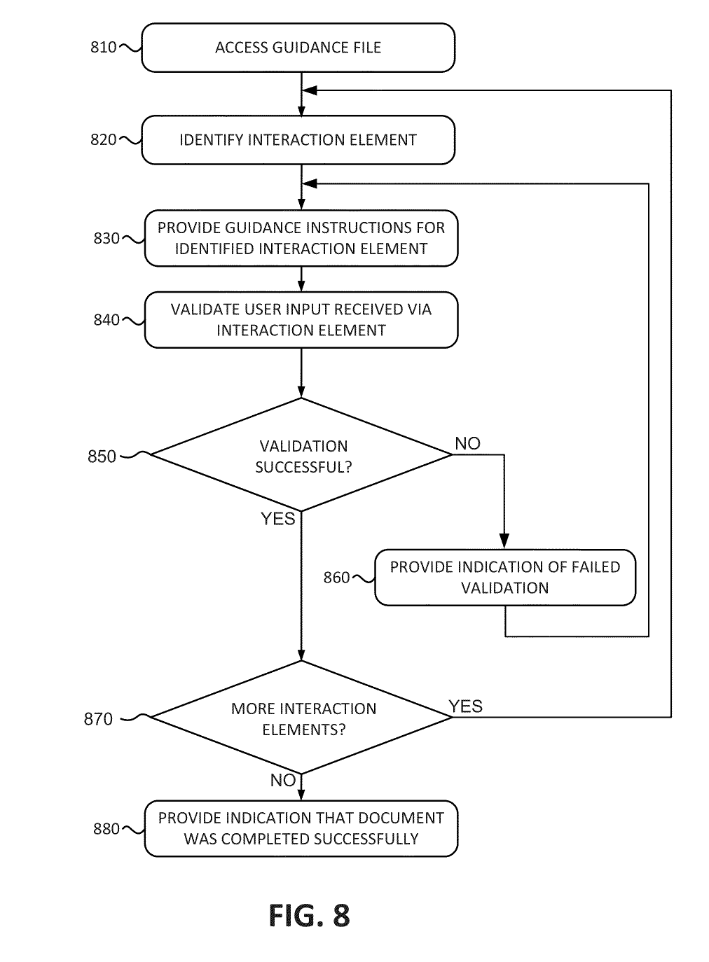

FIG. 8 is a flow chart of a first exemplary process for processing a guidance file according to an implementation described herein. The process of FIG. 8 may be used in connection with a guidance file designed for training purposes, which requires validation of user input. In one implementation, the process of FIG. 8 may be performed by client device 110. In other implementations, some or ail of the process of FIG. 8 may be performed by another device or a group of devices separate from client device 110 and/or including client device 110.

The process of FIG. 8 may include accessing a guidance file (block 810). For example, a user of client device 110 may access a document hosted by document hosting system 130, using a browser application. The document may include an instruction to retrieve script file 410. The browser application may retrieve script file 410 based on the instruction included in the document and may execute instructions included in script file 410. Script file 410 may include an instruction to process guidance file 450 and browser application may access guidance file 450 based on the instruction in script file 410.

An interaction element may be identified (block 820). For example, interaction element selection unit 412 of script file 410 may include instruction to identify a first interaction element in the accessed document by accessing interaction element ID field 462-A of guidance file 450 and identify the first interaction element in the document. In one implementation, the identified interaction element may be highlighted.

Guidance instructions may be provided for the identified element (block 830). For example, script file 410 may include an instruction to retrieve the guidance instructions from guidance instructions field 464-A of interaction element object 460-A and the browser application may retrieve the guidance instructions and display the guidance instructions in accordance with specifications included in the guidance instructions. For example, the guidance instructions may include information about a type of style and/or format of text, whether the text is to be provided in an audible format, information about a type of display box in which the text is to be displayed, information about where in relation to the interaction element the guidance instruction are to be displayed (e.g., a particular number of pixels above the interaction element), and/or any other type of information that may specify how the guidance instructions are to be provided to the user. In one implementation, how the guidance instructions are to be provided to the user may be specified in guidance instructions field 464-F of interaction element object 460-A of guidance file 450. In another implementation, some or all of the instructions about how the guidance instructions are to be provided to the user may be specified in guidance instructions providing unit 414 of script file 410.

User input via the interaction element may be validated (block 840). For example, the browser application may execute instructions included in input validation unit 416 to validate user input received via the identified interaction element. For example, the browser application may compare input received from the user via the identified interaction element with validation data stored in validation data field 466-A of interaction element object 460-A of guidance file 450. In some situations, validation data field 466-A need not include any validation data and validation need not be performed for a particular interaction element. In a situation where no validation needs to be performed for a particular interaction element, the validation may be determined to be valid by default.

A determination may be made as to whether the validation was successful (block 850). For example, the browser application may determine whether user input received via the identified interaction element matches the validation data stored in validation data field 466-A. If it is determined that the validation was not successful (block 860—NO), an indication of failed validation may be provided (block 860). For example, the browser application may display a message to the user indicating that the user has not provided the required input (e.g., based on a failed validation message included in header field 455 of guidance file 450). Processing may return to block 830.

If it is determined that the validation was successful (block 860—YES), a determination may be made as to whether there are more interaction elements to be processed (block 870). For example, the browser application may process script file 410 to execute instructions to access guidance file 450 to determine whether additional interaction element objects 460 remain to be processed. If it is determined that there are more interaction elements to be processed (block 870—YES), processing may return to block 820 to identify a next interaction element. If it is determined that there are no more interaction elements to be processed (block 870—NO), an indication may be provided that the document was completed successfully (block 880). For example, the browser application may display a message to the user indicating that the user has successfully completed processing of the document (e.g., based on a completion message included in header field 455 of guidance file 450).

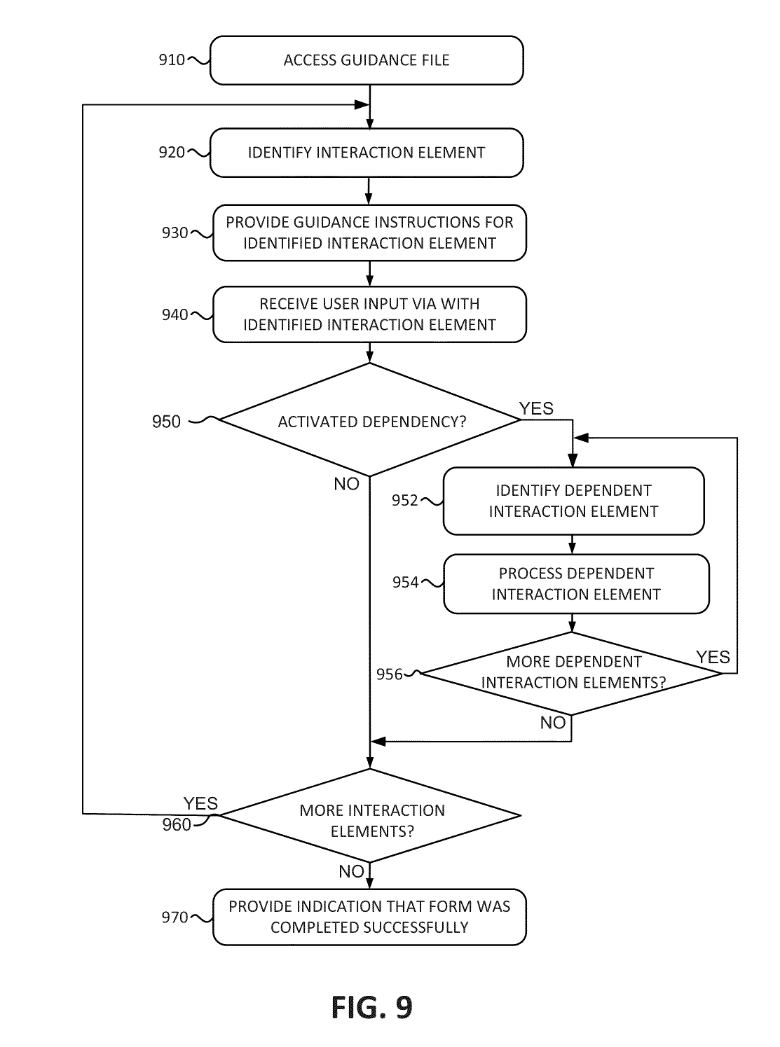

FIG. 9 is a flow chart of a second exemplary process for processing a guidance file according to an implementation described herein. The process of FIG. 9 may be used in connection with a guidance file that guides a user through a document, and which may require checking interaction elements for dependencies. In one implementation, the process of FIG. 9 may be performed by client device 110. In other implementations, some or all of the process of FIG. 9 may be performed by another device or a group of devices separate from client device 110 and/or including client device 110.

The process of FIG. 9 may include blocks 910-930, which may correspond to blocks 810-830, described above with reference to FIG. 8. Processing may continue by receiving input associated with the identified interaction element (block 940). For example, the browser application of client device 110 may receive input from the user via the identified interaction element.

A determination may be made as to whether the received user input has activated a dependency (block 950). For example, the browser application may compare input received from the user via the identified interaction element with information stored in next interaction element field 468 of interaction element object 460 of guidance file 450. Next interaction element field 468 may associate particular user input with a particular interaction element (e.g., selection 1 corresponds to a first next interaction element, selection 2 corresponds to a second next interaction element, etc.).

If it is determined that a dependency has been activated (block 950—YES), a dependent interaction element may be identified (block 952) and the dependent interaction element may be processed (block 954). For example, the browser application may determine the dependent next interaction element from next interaction element field 468 of the identified interaction element and may provide guidance instructions for the identified dependent interaction element (as described above with reference to block 830). A determination may be made as to whether there are more dependent interaction elements (block 956). For example, the browser application may access next interaction element field 468 of the dependent interaction element whether a next interaction element is identified. If it is determined that there are more dependent interaction elements (block 956—YES), processing may return to block 952 to identify the next dependent interaction element. If it is determined that there are no more dependent interaction elements (block 956—NO), processing may continue to block 960.

If it is determined that a dependency has not been activated (block 950—NO), a determination may be made as to whether there are more interaction elements to be processed (block 960). For example, the browser application may process script file 410 to execute instructions to access guidance file 4540 to determine whether additional interaction element objects 460 remain to be processed. If it is determined that there are more interaction elements to be processed (block 960—YES), processing may return to block 920 to identify a next interaction element. If it is determined that there are no more interaction elements to be processed (block 960—NO), an indication may be provided that the document was completed successfully (block 970). For example, the browser application may display a message to the user indicating that the user has successfully completed processing of the document (e.g., based on a completion message included in header field 455 of guidance file 450).

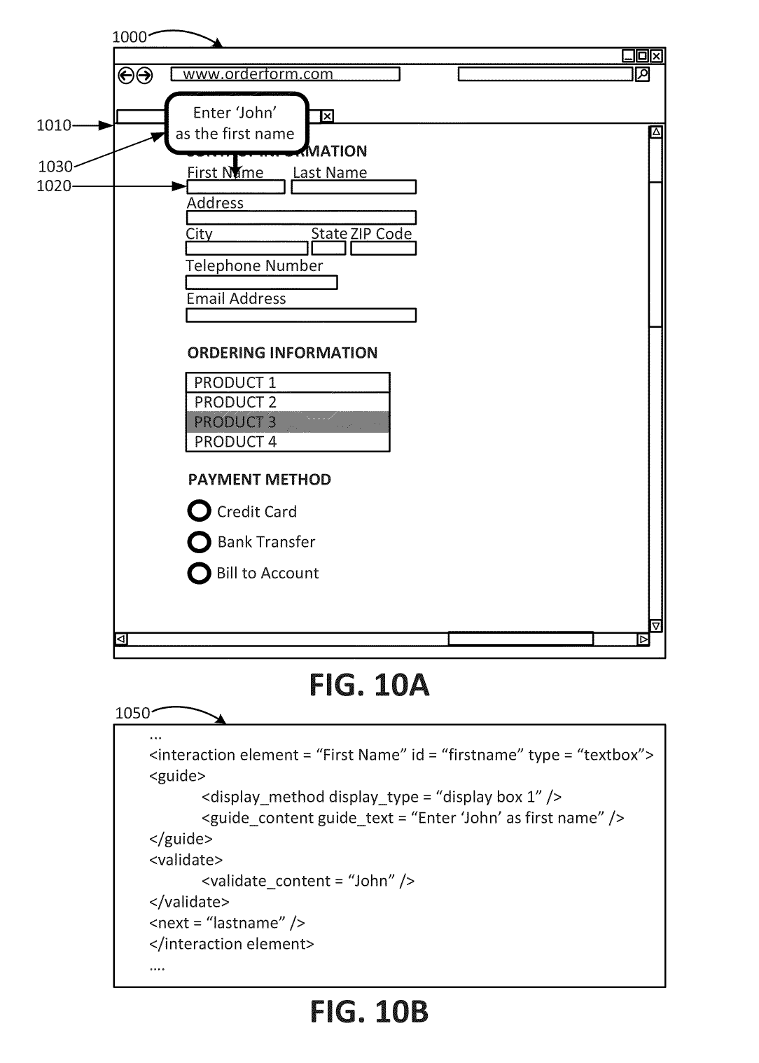

FIG. 10A is diagram of a first example 1000 of processing a training guidance file. As shown in FIG. 10A, example 1000 may include a user interface 1010. User interface 1010 may include a document being displayed by a browser application running on client device 110. The document may include a form that includes a contact information section for entering a name, address, phone number, and email through a set of text boxes. The document may further include an ordering section information that includes a drop down menu with an option to select a product out of four possible products. Furthermore, the document may include a payment method section that includes radio buttons to select a payment method.

The document may include an instruction to load script file 410. When the browser application accesses the document, the browser application may execute the instruction and consequently execute script file 410. The script file 410 may access guidance file 450 and retrieve guidance instructions for the first interaction element, which may be the first name text box 1020. The guidance instructions 1030 may be displayed within a particular distance from the first interaction element.

FIG. 10B is a diagram of a guidance file portion 1050 that may include guidance instructions 1030. As shown in FIG. 10B, guidance file portion 1050 may include a tag that includes an identifier for first name text box 1020, a “guide” tag that include guide text and that specifies a display method for the guide text, a “validate” tag that include validation text that is to be compared with user input, and a “next” tag that identifies a next interaction element (in this case, the last name text box).

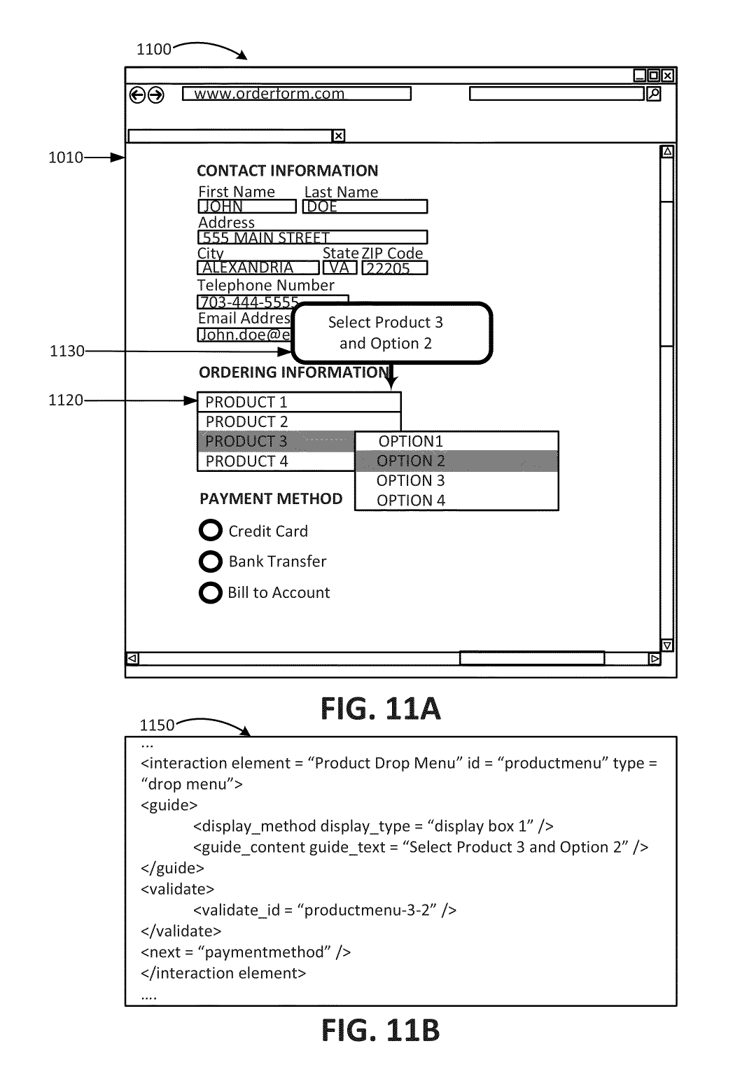

FIG. 11A is a diagram of a second example 1100 of processing a training guidance file. As shown in FIG. 11A, example 1100, which includes user interface 1010 with the same document as shown in FIG. 10A, includes guidance instructions 1130 provided for drop down menu 1120 that instruct the user to select product 3 and option 2.

FIG. 11B is a diagram of a guidance file portion 1150 that may include guidance instructions 1130. As shown in FIG. 11B, guidance file portion 1150 may include a tag that includes an identifier for drop down menu 1120, a “guide” tag that include guide text and that specifies a display method for the guide text, a “validate” tag that include validation information that is to be compared with user input, and a “next” tag that identifies a next interaction element.

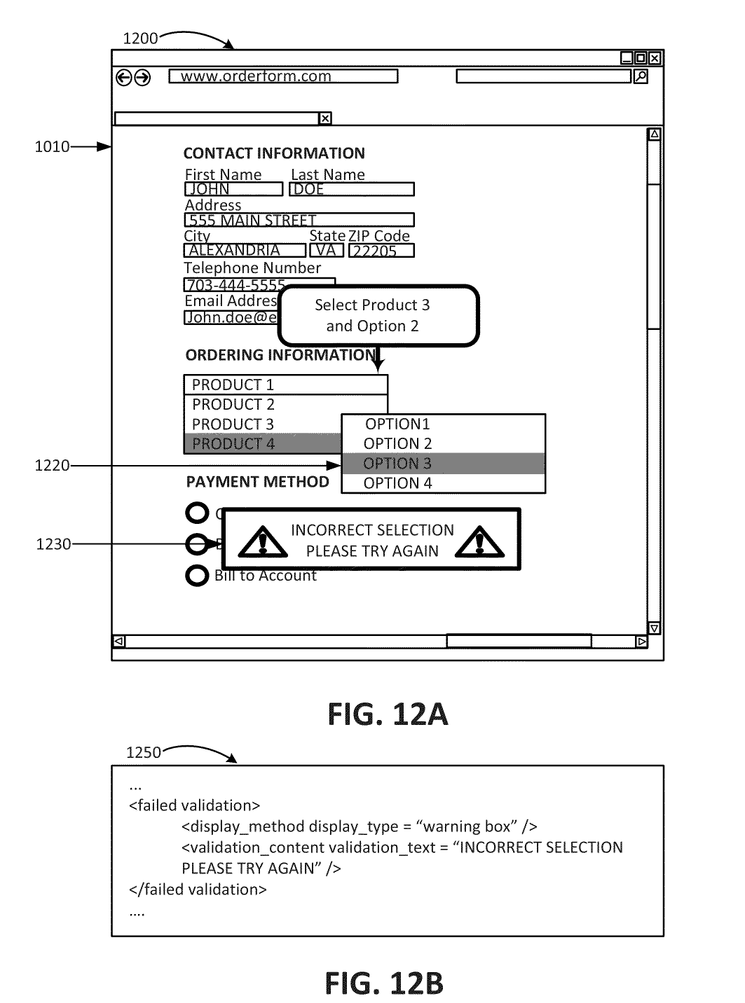

FIG. 12A is a diagram of a third example 1200 of processing a guidance file that includes indication of a failed validation. As shown in FIG. 12A, example 1100, which includes user interface 1010 with the same document as shown in FIG. 10A, shows that user input 1220 does not correspond to guidance instructions 1130, leading to a failed validation indication 1230 being provided to the user.

FIG. 12B is a diagram of a guidance file portion 1250 that includes information to be provided to the user in case of a failed validation. As shown in FIG. 12B, guidance file portion 1250 may include a “failed validation” tag that includes text that is to be provided to the user in case of a failed validation.

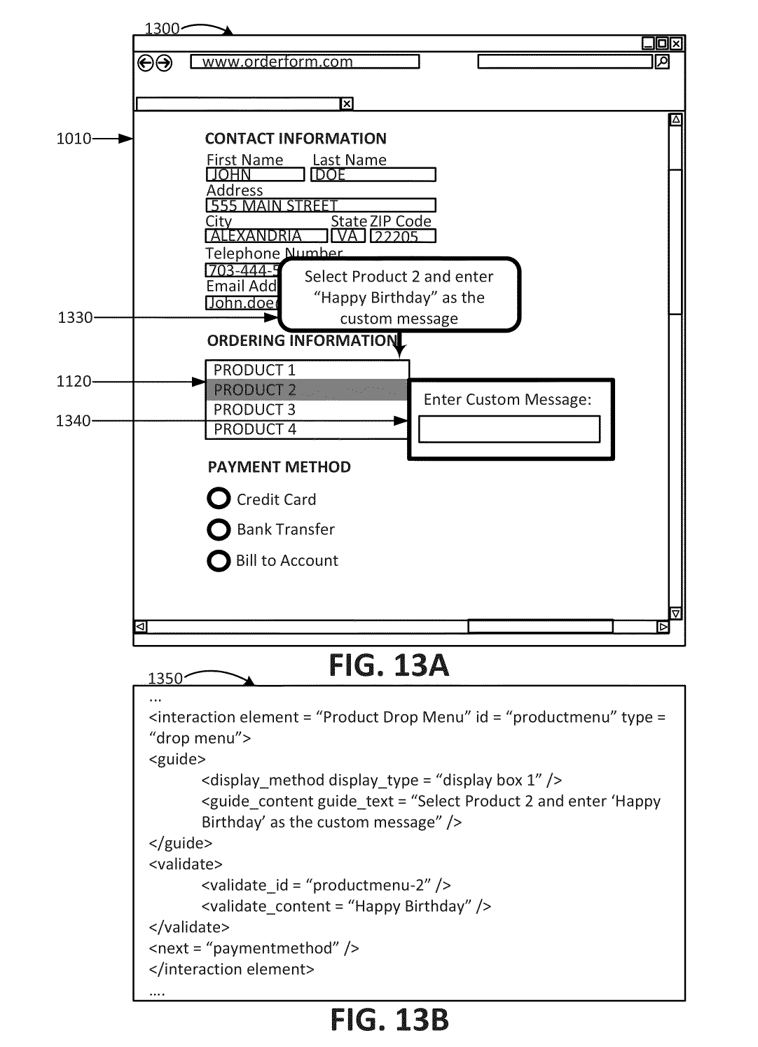

FIG. 13A is a diagram of a fourth example 1300, which includes user interface 1010 with the same document as shown in FIG. 10A, and which shows a different guidance file being provided for the same document. Example 1300 includes guidance instructions 1330 provided for drop down menu 1120 that instruct the user to select product 2 and to enter “Happy Birthday” for a custom message to be provided in connection with product 2.

FIG. 13B is a diagram of a guidance file portion 1350 that may include guidance instructions 1330. As shown in FIG. 13B, guidance file portion 1350 may include a tag that includes an identifier for drop down menu 1120, a “guide” tag that include guide text “Select Product 2 and enter ‘Happy Birthday’ as the custom message”, a “validate” tag that include validation text “Happy Birthday.”

Thus, a training guidance file for a document may be changed for a document, or a different guidance file may be used for the document, without having to change any code or metadata associated with the document.

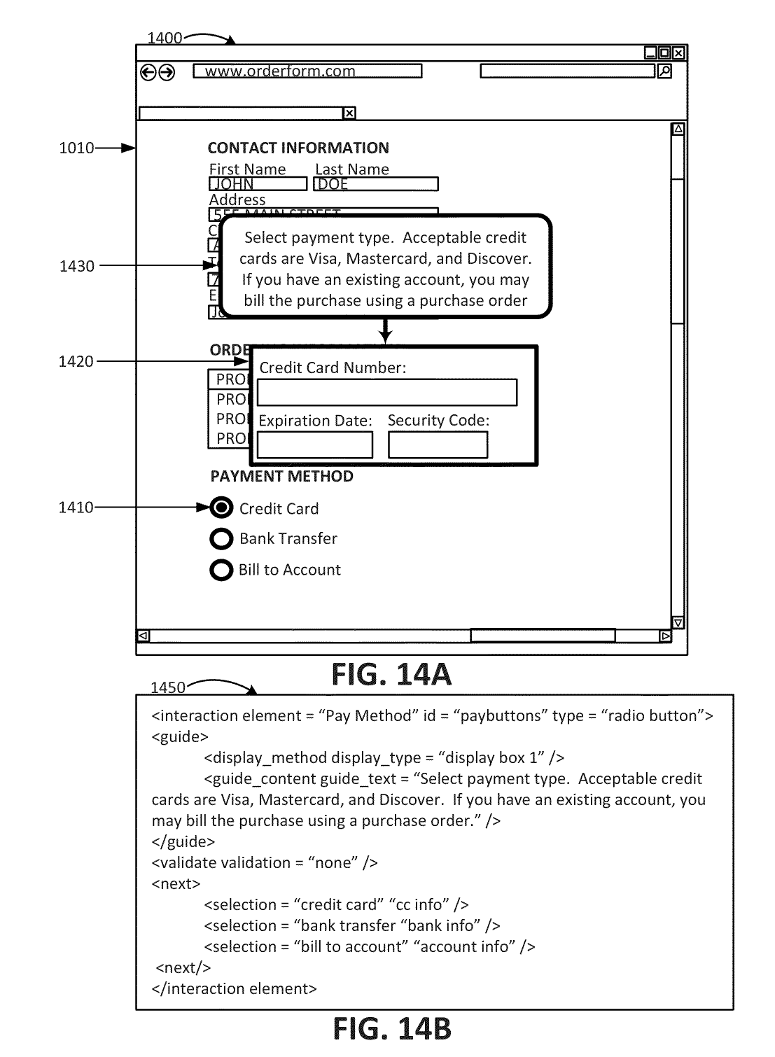

FIG. 14A is a diagram of a fifth example 1400 of providing a guidance file for a document. Example 1400 illustrates a dependent interaction element. A user may select radio button 1410 to select a credit card payment method, and in response, interaction element 1420 may be activated to prompt the user to enter credit card information. In response to interaction element 1420 being activated, guidance instructions 1430 may be provided in connection with interaction element 1420.

FIG. 14B is a diagram of a guidance file portion 1450 that may include guidance instructions 1430. As shown in FIG. 14B, guidance file portion 1450 may include a “next” tag that identified a next interaction element based on user input received via radio button 1410. Thus, if the user select radio button 1410, the next interaction element to be processed may be interaction element 1420, which may be associated with identifier “cc info.” In this example, if other credit cards are later added as being acceptable, guidance instructions 1430 may be changed to inform a user of the acceptable credit cards, without having to alter the document.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while particular devices and processes have been described with respect to telephone calls, in another implementation, the devices and processes may be implemented with respect to sending text messages.

As another example, a screen that informs a user about an incoming and/or outgoing call to or from a contact may display information about the contact, such as, for example, a local time associated with the contact, an appropriateness level associated with the contact, weather information associated with the contact, local event information associated with the contact, and/or any other information associated with the contact.

As yet another example, while series of blocks have been described with respect to FIGS. 5-9, the order of the blocks may be modified in other implementations. Further, non-dependent blocks may be performed in parallel.

It will be apparent that systems and/or methods, as described above, may be implemented in many different forms of software, firmware, and hardware in the implementations illustrated in the figures. The actual software code or specialized control hardware used to implement these systems and methods is not limiting of the embodiments. Thus, the operation and behavior of the systems and methods were described without reference to the specific software code—it being understood that software and control hardware can be designed to implement the systems and methods based on the description herein.

Further, certain portions, described above, may be implemented as a component that performs one or more functions. A component, as used herein, may include hardware, such as a processor, an ASIC, or a FPGA, or a combination of hardware and software (e.g., a processor executing software).

It should be emphasized that the terms “comprises”/“comprising” when used in this specification are taken to specify the presence of stated features, integers, steps or components but does not preclude the presence or addition of one or more other features, integers, steps, components or groups thereof.

No element, act, or instruction used in the present application should be construed as critical or essential to the embodiments unless explicitly described as such. Also, as used herein, the article “a” is intended to include one or more items. Further, the phrase “based on” is intended to mean “based, at least in part, on” unless explicitly stated otherwise.

What is claimed is:

1. A method performed by a computer device, the method comprising:
generating, by the computer device, a guidance file for a document, where the guidance file includes guidance instructions for one or more interactive elements in the document;
generating, by the computer device, a script file configured to cause the guidance file to be accessed and to provide the guidance instructions in connection with the one or more interactive elements; and
adding, by the computer device, an instruction to the document to run the script file when the document is accessed.

2. The method of claim 1, wherein the guidance file includes an extensible markup language file.

3. The method of claim 1, wherein the script file includes a Javascript file.

4. The method of claim 1, wherein the one or more interactive elements include at least one of:
a text box,
a drop down menu,
a checkbox,
a button,
a radio button, or
a clickable image.

5. The method of claim 1, wherein the generating the guidance file for the document includes:
identifying the one or more interaction elements in the document.

6. The method of claim 5, wherein the identifying the one or more interaction elements in the document includes:
identifying terms in tags of the document that are indicative of interactive elements.

7. The method of claim 1, wherein the generating the guidance file for the document includes:
determining whether a particular one of the one or more interaction elements includes an identifier; and
adding an identifier to the particular one of the one or more interaction elements, when the particular one of the one or more interaction elements does not include an identifier.

8. The method of claim 1, further comprising:
generating validation instructions for at least one of the one or more interaction elements, wherein the script file is configured to use the validation instructions to validate user input received via the at least one of the one or more interaction elements.

9. The method of claim 1, further comprising:
identifying a dependent interaction element for at least one of the one or more interaction elements:
identifying particular user input for the at least one of the one or more interaction elements that activates the dependent interaction element; and
including information about the dependent interaction element and about the particular user input in the guidance file in connection with the at least one of the one or more interaction elements.

10. The method of claim 1, further comprising:
determining a sequence for the one or more interactive elements in the document, wherein the guidance instructions for the one or more interactive elements are provided based on the determined sequence.

11. A computer device comprising:
a memory to store instructions; and
a processor configured to execute the instructions to:
generate a guidance file for a document, where the guidance file includes guidance instructions for one or more interactive elements in the document;
generate a script file configured to cause the guidance file to be accessed and to provide the guidance instructions in connection with the one or more interactive elements; and
add an instruction to the document to run the script file when the document is accessed.

12. The computer device of claim 11, wherein the guidance file includes an interactive element object for each of the one or more interactive elements, and wherein the interactive element object includes one or more of:
an interactive element identifier that identifies a particular interactive element;
a guidance instructions field that includes guidance instructions associated with the particular interactive element;
a validation instructions field that includes validation instructions associated with the particular interactive element, wherein the script file uses the validation instructions to validate user input received via the particular interaction element; or
a next interactive element field that includes an identifier that identifies a next interactive element to be processed by the script file.

13. The computer device of claim 11, wherein, when generating the guidance file for the document, the processor is further configured to:
identify the one or more interaction elements in the document by identifying terms in tags of the document that are indicative of interactive elements.

14. The computer device of claim 11, wherein, when generating the guidance file for the document, the processor is further configured to:
determine whether a particular one of the one or more interaction elements includes an identifier; and
add an identifier to the particular one of the one or more interaction elements, when the particular one of the one or more interaction elements does not include an identifier.

15. The computer device of claim 11, wherein the processor is further configured to:
generate validation instructions for at least one of the one or more interaction elements, wherein the script file is configured to use the validation instructions to validate user input received via the at least one of the one or more interaction elements.

16. The computer device of claim 11, wherein the processor is further configured to:
identify a dependent interaction element for at least one of the one or more interaction elements;
identify particular user input for the at least one of the one or more interaction elements that activates the dependent interaction element; and
include information about the dependent interaction element and about the particular user input in the guidance file in connection with the at least one of the one or more interaction elements.

17. A non-transitory computer-readable medium storing instructions executable by one or more processors, the non-transitory computer-readable medium comprising:
one or more instructions to generate a guidance file for a document, where the guidance file includes guidance instructions for one or more interactive elements in the document;
one or more instructions to generate a script file configured to cause the guidance file to be accessed and to provide the guidance instructions in connection with the one or more interactive elements; and
one or more instructions to add an instruction to the document to run the script file when the document is accessed.

18. The non-transitory computer-readable medium of claim 17, further comprising:
one or more instructions to determine whether a particular one of the one or more interaction elements includes an identifier; and
one or more instructions to add an identifier to the particular one of the one or more interaction elements, when the particular one of the one or more interaction elements does not include an identifier.

19. The non-transitory computer-readable medium of claim 17, further comprising:
one or more instructions to generate validation instructions for at least one of the one or more interaction elements, wherein the script file is configured to use the validation instructions to validate user input received via the at least one of the one or more interaction elements.

20. The non-transitory computer-readable medium of claim 17, further comprising:
one or more instructions to identify a dependent interaction element for at least one of the one or more interaction elements;
one or more instructions to identify particular user input for the at least one of the one or more interaction elements that activates the dependent interaction element; and
one or more instructions to include information about the dependent interaction element and about the particular user input in the guidance file in connection with the at least one of the one or more interaction elements.
